(19) United States
(12) Patent Application Publication
(10) Pub. No.: US 2025/0244811 A1
(43) Pub. Date: Jul. 31, 2025

(54) ELECTRONIC DEVICE AND METHOD OF CONTROLLING ELECTRONIC DEVICE

(71) Applicant: KYOCERA Corporation, Kyoto-shi (JP)

(72) Inventors: Kouta SUZUKI, Hadano-shi (JP); Koji IIDA, Yokohama-shi (JP); Shogo NISHI, Yokohama-shi (JP); Keiko AOKI, Yokohama-shi (JP)

(21) Appl. No.: 19/035,643

(22) Filed: Jan. 23, 2025

(30) Foreign Application Priority Data
Jan. 26, 2024 (JP) 2024-010551

(51) Int. Cl. G06F 1/26; G06F 1/28

(52) U.S. Cl. CPC G06F 1/263; G06F 1/28

(57) ABSTRACT

An electronic device is provided. The electronic device is configured to operate under power supplied from at least one of a first battery or a second battery. The electronic device comprises a controller. The controller is configured to carry out control to transition to a battery replacement mode for switching from a supply of power from the first battery to a supply of power from the second battery. The controller is configured to determine, when a predetermined operation by a user is detected, whether a transition to the battery replacement mode is possible. The determination is based on at least one of a state of the electronic device or a state of the second battery.

### CROSS REFERENCES TO RELATED APPLICATIONS

The present application contains subject matter related to Japanese Patent Application No. 2024-10551 filed in the Japan Patent Office on Jan. 26, 2024, the entire contents of which are incorporated herein by reference.

### BACKGROUND

### 1. Field

The present disclosure relates to an electronic device and a method of controlling an electronic device.

### 2. Description of the Related Art

Portable electronic devices such as smartphones and tablet have built-in batteries in many cases. The power of the batteries built into such electronic devices is limited. Accordingly, it is necessary to charge the battery built into an electronic device or replace the battery with another battery before the battery runs out of power.

Several technologies have been proposed to improve convenience and/or safety when replacing the battery of a portable electronic device. For example, Japanese Unexamined Patent Application Publication No. 2018-7474 proposes a portable terminal provided with an auxiliary power supply capacitor capable of supplying power in place of a main battery. This allows for removal of the battery while maintaining a partial supply of power. Japanese Unexamined Patent Application Publication No. 2021-87228 proposes a portable terminal that inhibits battery removal without powering off when a hot swap function is unavailable. Japanese Unexamined Patent Application Publication No. 2017-153203 proposes a portable terminal provided with a first battery and a second battery. The portable terminal inhibits momentary interruption when switching out these batteries.

### SUMMARY

In one embodiment, an electronic device is provided. The electronic device is configured to operate under power supplied from at least one of a first battery or a second battery. The electronic device includes a controller. The controller is configured to carry out control to transition to a battery replacement mode for switching from a supply of power from the first battery to a supply of power from the second battery. The controller is configured to determine, when a predetermined operation by a user is detected, whether a transition to the battery replacement mode is possible. The determination is based on at least one of a state of the electronic device or a state of the second battery.

In one embodiment, a method for controlling an electronic device is provided. The electronic device is configured to operate under power supplied from at least one of a first battery or a second battery. The control method includes carrying out control to transition to a battery replacement mode for switching from a supply of power from the first battery to a supply of power from the second battery. The control method includes determining, when a predetermined operation by a user is detected, whether a transition to the battery replacement mode is possible. The determination is based on at least one of a state of the electronic device or a state of the second battery.

### BRIEF DESCRIPTION

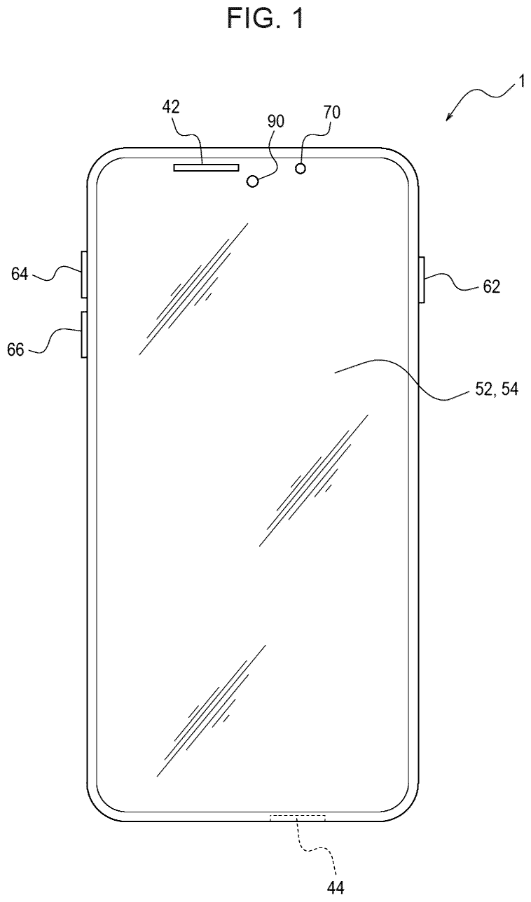

FIG. 1 is a diagram illustrating an example of the external appearance of an electronic device according to an embodiment;

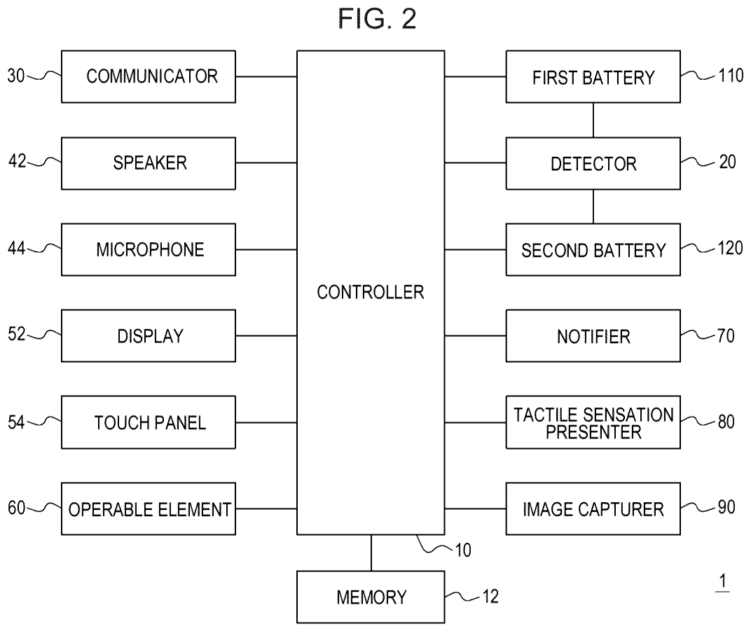

FIG. 2 is a block diagram schematically illustrating a functional configuration of an electronic device according to one embodiment;

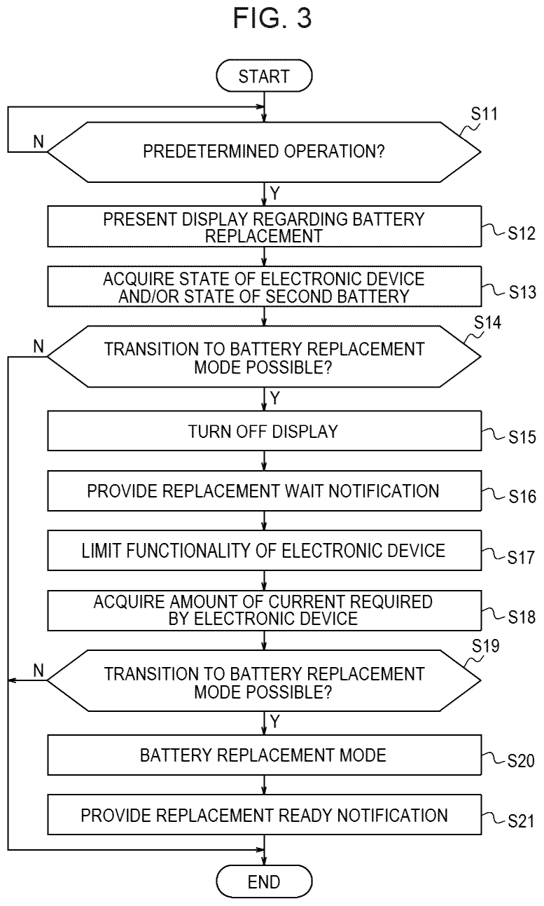

FIG. 3 is a flowchart illustrating an example of operations by an electronic device according to one embodiment;

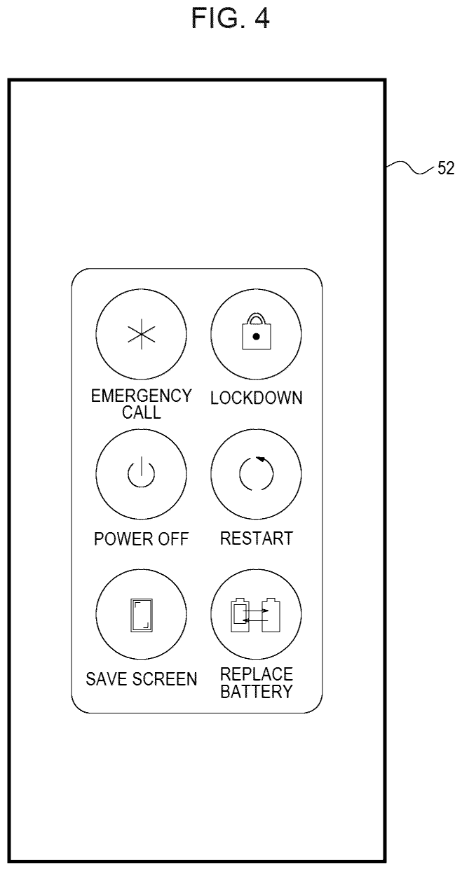

FIG. 4 is a diagram illustrating an example of a display on a display of an electronic device according to one embodiment;

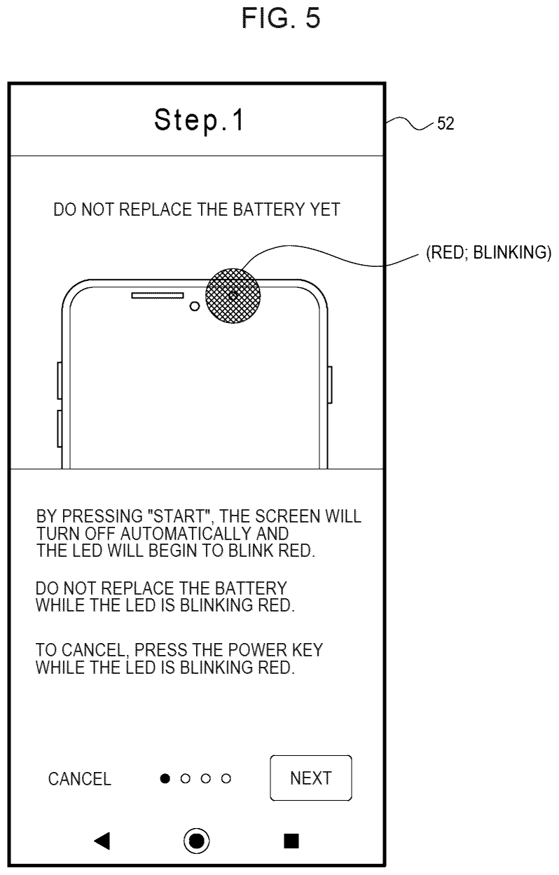

FIG. 5 is a diagram illustrating an example of a display on a display of an electronic device according to one embodiment;

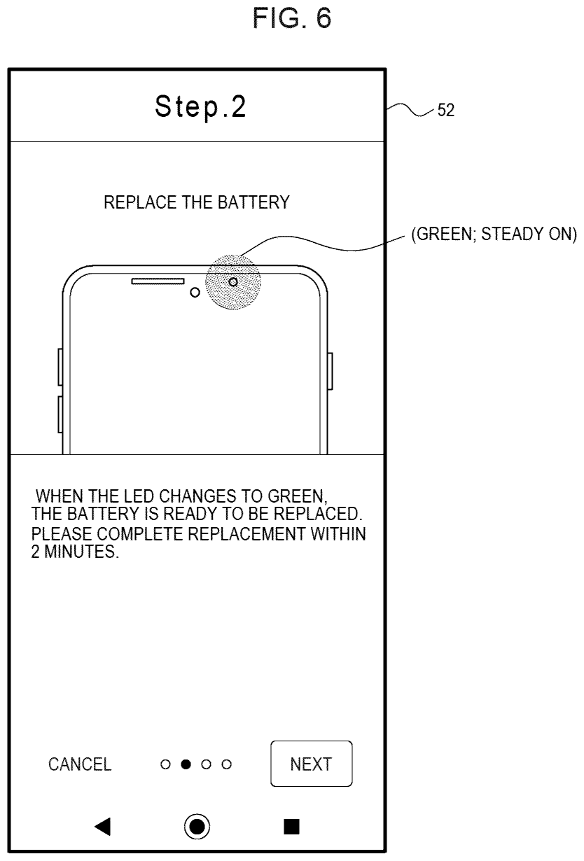

FIG. 6 is a diagram illustrating an example of a display on a display of an electronic device according to one embodiment;

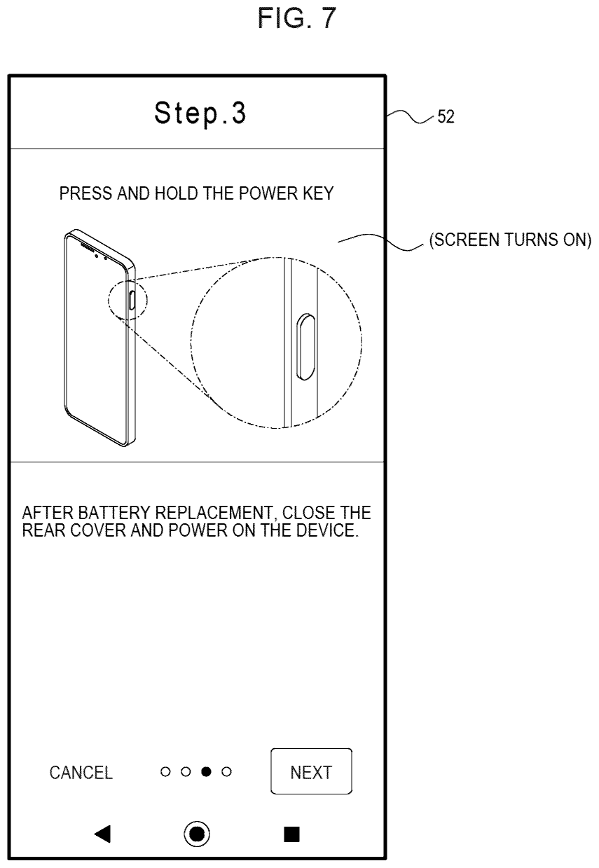

FIG. 7 is a diagram illustrating an example of a display on a display of an electronic device according to one embodiment;

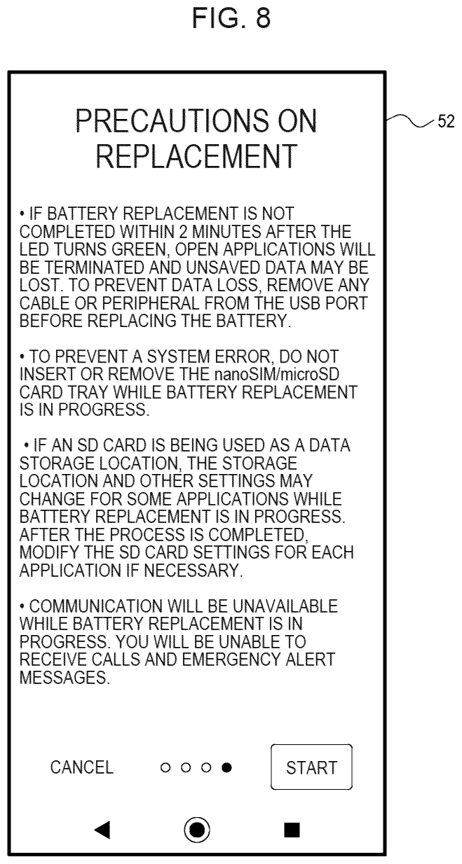

FIG. 8 is a diagram illustrating an example of a display on a display of an electronic device according to one embodiment;

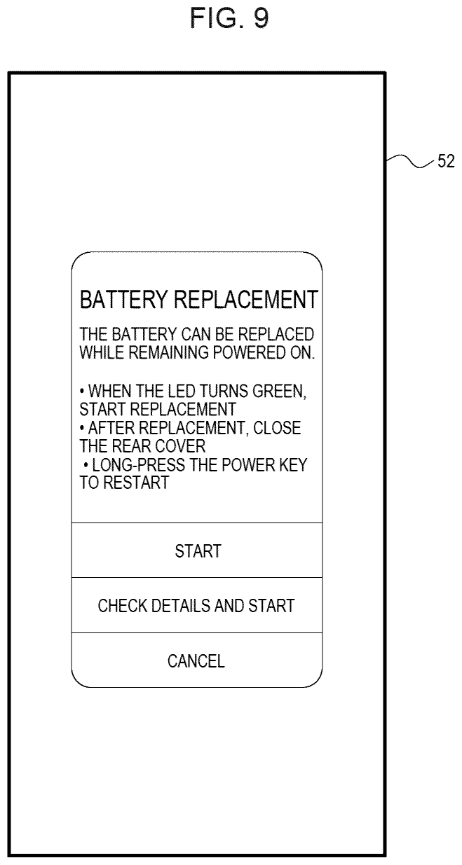

FIG. 9 is a diagram illustrating an example of a display on a display of an electronic device according to one embodiment;

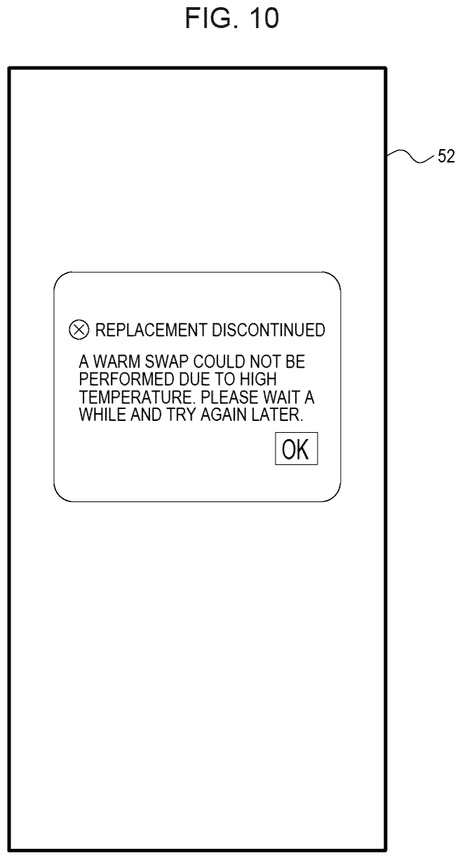

FIG. 10 is a diagram illustrating an example of a display on a display of an electronic device according to one embodiment;

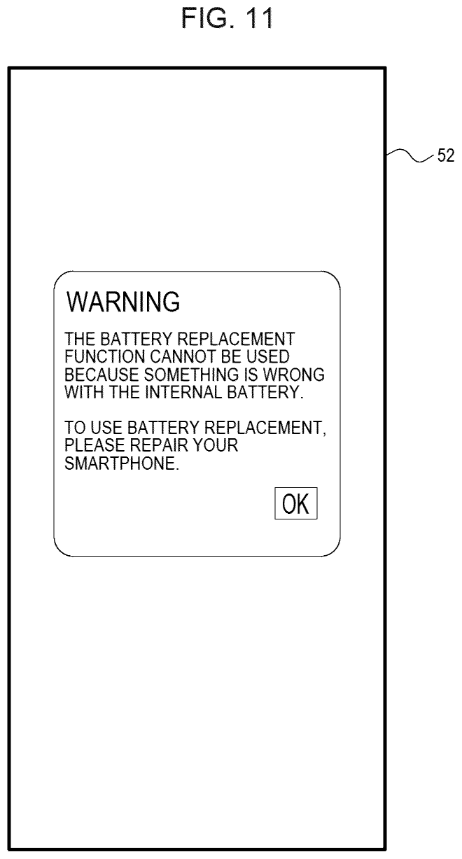

FIG. 11 is a diagram illustrating an example of a display on a display of an electronic device according to one embodiment;

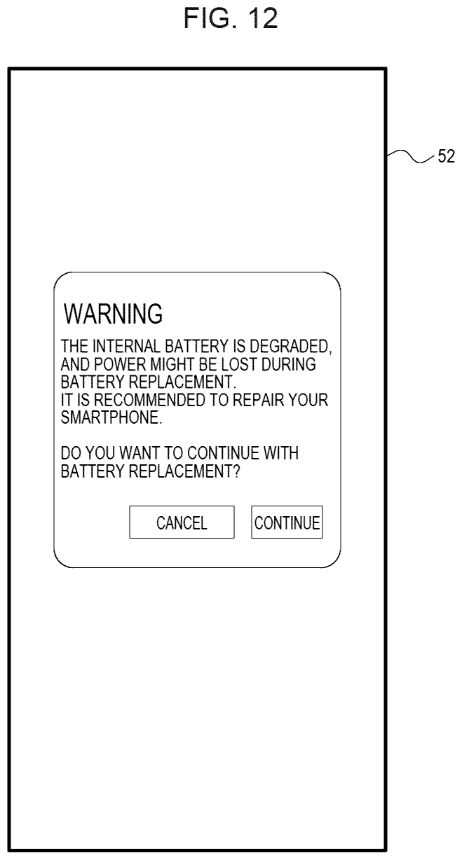

FIG. 12 is a diagram illustrating an example of a display on a display of an electronic device according to one embodiment;

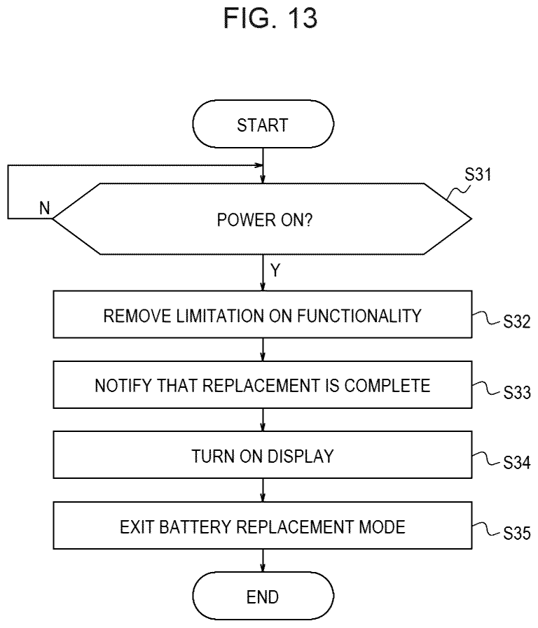

FIG. 13 is a flowchart illustrating an example of operations by an electronic device according to one embodiment; and

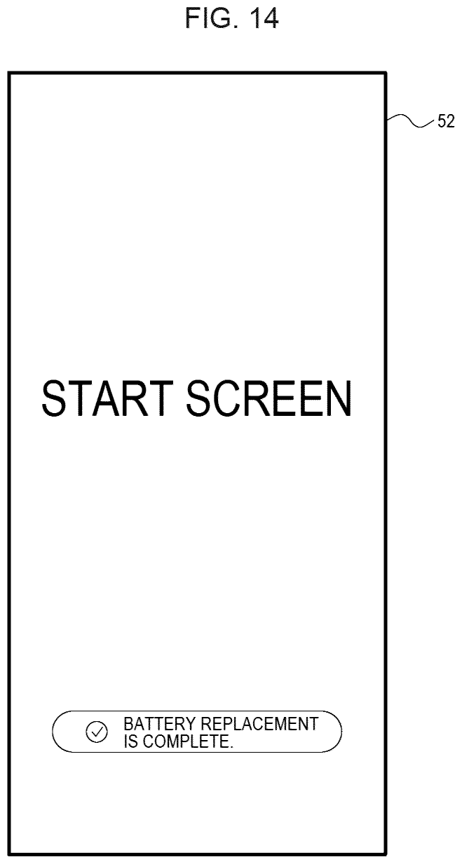

FIG. 14 is a diagram illustrating an example of a display on a display of an electronic device according to one embodiment.

### DESCRIPTION OF THE PREFERRED EMBODIMENTS

Further improvements are desired in convenience and/or safety when replacing the battery of a portable electronic device. The present disclosure relates to an electronic device that may improve convenience and/or safety when replacing the battery. The present disclosure also relates to a method of controlling such an electronic device. According to an embodiment, an electronic device that may improve convenience and/or safety when replacing the battery can be provided. According to an embodiment, a method of controlling such an electronic device can be provided.

In the present disclosure, an “electronic device” may be a device driven by electric power. A “user” may be an entity (typically a human being) that uses an electronic device according to an embodiment and/or a system including the electronic device. According to an embodiment, the user can use the electronic device to experience improved convenience and/or safety when replacing the battery of the electronic device.

In the present disclosure, “hot swap” may mean attaching/removing a peripheral while a peripheral or the main device is powered on, for example. In the present disclosure, “warm swap” may mean attaching/removing a peripheral while the peripheral or the main device is in a suspended state, for example.

As an example, replacing a main battery by a warm swap may necessitate switching from power supplied by a main battery to power supplied by a sub-battery. When switching the supply of power from the main battery to the sub-battery, it is desirable to check whether the remaining capacity of the sub-battery is at least a certain level. On the other hand, since expanding the capacity of the sub-battery can cause an increase in cost and/or size, a sub-battery of relatively low capacity tends to be desired.

A relatively complex system such as a mobile phone or smartphone may not have a constant current draw. Consequently, when replacing the main battery in such a system, a low-capacity sub-battery may be unable to maintain the power that the overall system requires.

Supplementing the supply of power to the system with a low-capacity sub-battery necessitates reducing or otherwise limiting the system current draw. However, depending on the state of the system, lowering the current draw to a level that allows for supplementation with power from the sub-battery may not be possible.

As described above, replacing the main battery raises concerns that the safety of the system may not be ensure and that user convenience may be impaired. An embodiment described below provides an electronic device that can smoothly switch to power supplied by a sub-battery without interrupting power to the device, even with a sub-battery of relatively low capacity, for example. According to an embodiment, the user can use the electronic device to experience improved convenience and/or safety when replacing the battery.

FIG. 1 is a diagram illustrating an example of the external appearance of an electronic device according to an embodiment.

As illustrated in FIG. 1, in one embodiment, an electronic device 1 may be smartphone, for example. However, in one embodiment, the electronic device 1 is not limited to a smartphone. For example, the electronic device 1 may also be realized as a tablet (personal computer), a phablet, a mobile phone, or a feature phone, for example. In one embodiment, the electronic device 1 is not limited to a device like the abovementioned and may also be realized as any of various types of devices, such as special-purpose devices. In one embodiment, the electronic device 1 may be realized as a personal digital assistant (PDA), a remote control terminal, a portable music player, a game console, an ebook reader, a home appliance, or industrial equipment (FA equipment), for example. In one embodiment, the electronic device 1 may be any of various types of devices that detect an operation by the user to thereby execute processing according to the operation. In one embodiment, the electronic device 1 may be any electronic device that can accommodate a battery and operate by using an installed battery. The following describes a form of one embodiment in which the electronic device 1 is realized as a smartphone or other device having a function of detecting user operations.

In one embodiment, the electronic device 1 may have a housing with the same and/or similar external appearance as the illustration in FIG. 1, for example. As illustrated in FIG. 1, the electronic device 1 may include a speaker 42, a microphone 44, a display 52, a touch panel 54, an operable element (power key) 62, an operable element (volume up key) 64, an operable element (volume down key) 66, a notifier 70, and an image capturer 90. In one embodiment, the electronic device 1 may include at least some of the functional units illustrated in FIG. 1, and may also include functional units other than the functional units illustrated in FIG. 1.

The speaker 42 and the microphone 44 may be a sound output unit and a sound input unit that function in the same and/or similar way as a speaker and a microphone used for voice calls in an ordinary smartphone. The display 52 may be a functional unit that is the same and/or similar to a liquid-crystal display (LCD) or an organic light-emitting diode (OLED) display used in an ordinary smartphone. A pictograph display such as a battery pictograph and/or a radio wave pictograph may also be displayed in the upper part of the display so that the remaining capacity of an internal battery and/or the radio wave strength can be understood at a glance. The touch panel 54 may a functional unit that detects touches, taps, swipes, or other operations by the user, in the same and/or similar way as a touch panel used in an ordinary smartphone.

The operable element (power key) 62, operable element (volume up key) 64, and operable element (volume down key) 66 may be pushbutton switches for realizing corresponding functions, in the same and/or similar way as operable elements used in an ordinary smartphone. Hereinafter, the operable element (power key) 62, operable element (volume up key) 64, and operable element (volume down key) 66 are simply referred to as the “operable element 60” when not being distinguished individually.

The notifier 70 may function as an indicator of any kind, in the same and/or similar way as an LED used in an ordinary smartphone. The notifier 70 can emit light in a color such as green or red, for example, and can notify the user of certain information by performing operations such as turning on, turning off, or blinking in each color. The image capturer 90 may be a functional unit that is the same and/or similar to a camera used in an ordinary smartphone.

FIG. 2 is a block diagram schematically illustrating a functional configuration of the electronic device 1 according to an embodiment.

As illustrated in FIG. 2, in one embodiment, an electronic device 1 may be provided with a controller 10. In one embodiment, the controller 10 of the electronic device 1 may be connected to a memory 12 and a detector 20. In one embodiment, the controller 10 of the electronic device 1 may be connected to a communicator 30, a speaker 42, a microphone 44, a display 52, a touch panel 54, and an operable element 60. In one embodiment, the controller 10 of the electronic device 1 may be connected to a notifier 70, a tactile sensation presenter 80, and an image capturer 90. In one embodiment, the controller 10 of the electronic device 1 may be connected to a first battery 110 and a second battery 120. As illustrated in FIG. 2, each functional unit is electrically connected to the controller 10, as appropriate.

Among the functional units illustrated in FIG. 2, the speaker 42, microphone 44, display 52, touch panel 54, operable element 60, notifier 70, and image capturer 90 may be the same and/or similar to those described in FIG. 1. A more detailed description of these functional units is omitted.

The controller 10 controls operations by the electronic device 1 as a whole, including control of the functional units that form the electronic device 1. The controller 10 centrally controls operations by the electronic device 1 to realize various functions.

To provide control and processing power for executing various functions, the controller 10 may include at least one processor, such as a central processing unit (CPU) or a digital signal processor (DSP). The controller 10 may be realized entirely with a single processor, with several processors, or with respectively separate processors. The processor may be realized as a single integrated circuit. An integrated circuit is also referred to as an IC. The processor may be realized as multiple communicatively connected integrated circuits and discrete circuits. The controller 10 may be an integrated circuit such as a system-on-a-chip (SoC) into which other components are integrated. The controller 10 may be formed by combining multiple integrated circuits. The processor may be realized on the basis of any of various other known technologies. In one embodiment, the controller 10 may be configured as a CPU (hardware) and a program (software) executed by the CPU, for example. The controller 10 may include one or both of software and hardware resources, for example. In one embodiment, the controller 10 may be configured by specific means in which software and hardware resources work together.

The controller 10 may be configured as a CPU or DSP and a program executed by the CPU or DSP, for example. The program executed in the controller 10, a result of processing executed in the controller, and the like may be stored in a memory of any kind, for example. The controller 10 may include a memory necessary for operations by the controller 10, as appropriate.

The memory 12 serves as storage for storing programs and data. The memory 12 can store the results of processing by the controller 10. The memory 12 may include a storage device of any kind, such as a semiconductor storage device and a magnetic storage device. The memory 12 may include multiple kinds of storage devices. The memory 12 may include a combination of a memory card or other portable storage medium and a reader for reading the storage medium.

The programs stored in the memory 12 may include an application to be executed in the foreground or background and a control program that supports operations by the application. The application causes the controller 10 to execute processing according to gestures, for example. The control program may be an operating system (OS), for example. The application and the control program may be installed in the memory 12 via communication by the communicator 30 or via a storage medium. The data stored in the memory 12 includes various kinds of information, such as still images (photos), videos, and text information. This information may be acquired and updated via the communicator 30.

The first battery 110 and the second battery 120 both function as power sources capable of supplying power to the electronic device 1. In one embodiment, the electronic device 1 may be configured to operate under power supplied from at least one of the first battery 110 or the second battery 120. The first battery 110 and the second battery 120 both may be secondary batteries that can be used by being charged and discharged repeatedly.

The capacities of the first battery 110 and the second battery 120 are not particularly limited, but the first battery 110 may have a higher capacity than the second battery 120, for example. The first battery 110 may have a higher capacity than the second battery 120 to function as a main battery, for example. On the other hand, the second battery 120 may have a lower capacity than the first battery 110 to function as a sub (auxiliary) battery, for example.

In the following, multiple first batteries 110 that can be connected to the electronic device 1 are distinguished as the first battery 110A, the first battery 110B, and so on. For example, in one embodiment, the electronic device 1 may be configured such that the first battery 110 connected to the electronic device 1 can be swapped from the first battery 110A to the first battery 110B. In this case, in one embodiment, the electronic device 1 may be configured such that the connected first battery 110A can be disconnected (the first battery 110A can be removed from the electronic device 1) and replaced with the first battery 110B. For example, the electronic device 1 may be configured such that the housing thereof or at least a portion of the housing, such as a panel or lid, is removable. In this way, by configuring the first battery 110 built into the electronic device 1 to be user-accessible, the user can swap the first battery 110A built into the electronic device 1 with another first battery 110B.

On the other hand, in one embodiment, the second battery 120 of the electronic device 1 may also be configured to be replaceable in the same and/or similar way as the first battery 110. On the other hand, in one embodiment, the second battery 120 of the electronic device 1 may be configured to remain built into the electronic device 1 and not be easily removable or replaceable.

The detector 20 is a collective term for functional units that perform predetermined detections with respect to at least one of the first battery 110 or the second battery 120. For example, the detector 20 may detect the temperature of at least one of the first battery 110 or the second battery 120. In this case, the detector 20 may include a detector such as a temperature sensor. As another example, the detector 20 may detect the voltage of at least one of the first battery 110 or the second battery 120. In this case, the detector 20 may include a detector such as a voltage sensor. As another example, the detector 20 may detect the degradation, or the degree of degradation, of at least one of the first battery 110 or the second battery 120. In this case, the detector 20 may include a predetermined sensor or the like to detect battery performance. As another example, the detector 20 may detect an abnormality pertaining to of at least one of the first battery 110 or the second battery 120. In this case, the detector 20 may include a predetermined sensor or the like to detect a battery abnormality. As another example, the detector 20 may detect an abnormality (for example, a short or damage to an electronic component) pertaining to a circuit through which at least one of the first battery 110 or the second battery 120 supplies power to the electronic device 1. In this case, the detector 20 may include a predetermined sensor or the like to detect an abnormality of the circuit for supplying power to the electronic device 1. The detector 20 may perform only one predetermined detection like the above-described, or have functions for performing multiple predetermined detections.

The above describes several examples of the detector 20, but the detector 20 is not limited to the examples described above. The detector 20 may be a functional unit that performs various kinds of detections with respect to at least one of the first battery 110 or the second battery 120. The detector 20 may also perform a predetermined detection with respect to only one of either the first battery 110 or the second battery 120. For example, the detector 20 may perform a predetermined detection with respect to the second battery 120 only.

For simplicity, FIG. 2 illustrates a form in which one detector 20 performs a predetermined detection with respect to at least one of the first battery 110 or the second battery 120. In one embodiment, separate detectors 20 may each perform various kinds of detections with respect to the first battery 110 and the second battery 120, for example. The detector 20 may include a detector 20A and a detector 20B, for example. In this case, the detector 20A may have a function for performing a predetermined detection with respect to the first battery 110, for example. The detector 20B may have a function for performing a predetermined detection with respect to the second battery 120, for example.

Depending on the detecting function with respect to each, the detector 20 may be electrically connected to, or disposed in the vicinity of, at least one of the first battery 110 or the second battery 120.

The communicator 30 is an interface for communicating in a wired and/or wireless way. The communicator 30 may include functional units such as a radio and an antenna. In one embodiment, the communication scheme implemented by the communicator 30 may be a wireless communication standard. For example, wireless communication standards include cellular phone communication standards such as 2G, 3G, 4G, and 5G. For example, cellular phone communication standards include Long Term Evolution (LTE), Wideband Code Division Multiple Access (W-CDMA), CDMA2000, Personal Digital Cellular (PDC), the Global System for Mobile Communications (GSM®), and the Personal Handy-phone System (PHS). For example, wireless communication standards include Worldwide Interoperability for Microwave Access (WiMAX), IEEE 802.11, Bluetooth®, the Infrared Data Association (IrDA), and near field communication (NFC). The communicator 30 can support one or more of the above communication standards.

The tactile sensation presenter 80 may be any functional unit having a haptics function such as a vibrator or a piezoelectric element. The tactile sensation presenter 80 may have a function of presenting a tactile sensation such as vibration to a finger that the user uses to operate the electronic device 1, for example. In one embodiment, the tactile sensation presenter 80 may be the combination of the display 52 and the touch panel 54, which function as a touch screen display. With such a configuration, when the user touches the display 52 to operate the electronic device 1, for example, the user can recognize a tactile sensation presented by the tactile sensation presenter 80.

In one embodiment, the electronic device 1 may include at least some of the functional units illustrated in FIG. 2, and may also include functional units other than the functional units illustrated in FIG. 2. At least some of the functional units other than the controller 10 illustrated in FIG. 2 may also be included in the controller 10. At least a portion of each functional unit illustrated in FIG. 2 may also be configured by specific means in which software and hardware resources work together.

The following further describes battery replacement in the electronic device 1 according to one embodiment.

In one embodiment, for example, during normal operation, the electronic device 1 may operate under power supplied from the first battery 110 which serves as the main battery. In this case, during operation different from the above normal operation, such as when replacing the first battery 110A with the first battery 110B, for example, the electronic device 1 may operate under power supplied from the second battery 120 which serves as the sub-battery.

The following assumes a situation where the electronic device 1 is operating under power supplied from the first battery 110A, the amount of remaining power charged in the first battery 110A decreases or the like, and thus replacing the first battery 110A with the first battery 110B is desired.

In such a case, the electronic device 1 may switch from power supplied from the first battery 110A to power supplied from the second battery 120, on the basis of a predetermined operation by the user, for example. In the following, “battery replacement mode” refers to the state (operating mode) in which a supply of power from the first battery 110A is switched to a supply of power from the second battery 120. In one embodiment, the controller 10 of the electronic device 1 may carry out control to transition to the battery replacement mode for switching from a supply of power from the first battery 110A to a supply of power from the second battery 120.

Once the electronic device 1 transitions to the battery replacement mode, the user can remove the first battery 110A from the body or the like of the electronic device 1 and swap in the first battery 110B. The first battery 110B in this case may be a secondary battery charged with predetermined power, a primary battery capable of outputting predetermined power, or the like. In this way, after replacing the first battery 110A with the first battery 110B, the electronic device 1 may switch the power source from the second battery 120 to the first battery 110B, and thereby operate under power supplied from the replaced first battery 110B.

However, in some conceivable situations, ensuring convenience and/or safety for the user may be difficult when transitioning to the battery replacement mode and replacing the first battery 110 as described above. For instance, assume an example of operation that transitions to the battery replacement mode immediately when the user performs a predetermined operation. In this case, a relatively high current draw occurs when, for example, the electronic device 1 is in the middle of a voice call or waiting for a callback during the execution of an emergency callback mode function. The emergency callback mode function is a mode that the electronic device 1 transitions to when an emergency call is terminated. The emergency callback mode function is used to allow an operator to call the user back or to identify the approximate location of the user. When switching to the second battery 120 while a relatively high current draw is occurring in this way, the current outputted by the second battery 120 may be insufficient, and communication may be interrupted momentarily. In such a case, if the electronic device 1 reduces the current draw without asking so that the current outputted by the second battery 120 is sufficient, the user may be disadvantaged. For example, communication up to that time may be cut off.

When transitioning to the battery replacement mode immediately when the user performs a predetermined operation, appropriate battery replacement may not be possible if the second battery 120 is experiencing some kind of malfunction or abnormality.

To cope with problems like the above, in one embodiment, the electronic device 1 operates so as to improve convenience and/or safety when replacing the battery. The following further describes such operations.

FIG. 3 is a flowchart illustrating an example of operations by the electronic device 1 according to an embodiment. The following refers to FIG. 3 to describe operations when the electronic device 1 transitions to the battery replacement mode on the basis of a user operation.

The following assumes that, at the time when the operations illustrated in FIG. 3 start, the electronic device 1 is operating under power supplied from the first battery 110A which serves as the main battery. The following also assumes that, at this time, the user recognizes that the remaining amount of power charged in the first battery 110A is running out, and the user desires to replace the first battery 110A with the fully charged first battery 110B.

When the operations illustrated in FIG. 3 start, the controller 10 determines whether a predetermined operation by the user is detected (step S11). The predetermined operation by the user may be any of various predefined operations for when the user desires to replace the first battery 110. On the basis of a long-press operation performed by the user on the operable element (power key) 62, the controller 10 may display a screen like the one illustrated in FIG. 4 on the display 52, for example. The controller 10 may determine that the “predetermined operation” has been performed on the basis of the user performing an operation of tapping the area of the touch panel 54 corresponding to the position of a “Battery Replacement” icon displayed on the display 52. That is, the “predetermined operation by the user” may be, for example, the user tapping the touch panel 54 at the position of the “Battery Replacement” icon on a screen like the one illustrated in FIG. 4, which is displayed on the display 52 on the basis of the user long-pressing the operable element 62.

If the predetermined operation by the user is not detected in step S11, the controller 10 may return to step S11 and continue operations.

On the other hand, if the predetermined operation by the user is detected in step S11, the controller 10 may display information pertaining to battery replacement on the display 52 (step S12). The information pertaining to battery replacement displayed on the display 52 in step S12 may present the user with a procedure for operating the electronic device 1 when replacing the first battery 110A with the first battery 110B, for example.

The information pertaining to battery replacement displayed in step S12 may be the information on the screens displayed on the display 52 in the order of FIG. 5, FIG. 6, FIG. 7, and FIG. 8, for example.

For example, the controller 10 may first display a screen like the one illustrated in FIG. 5 on the display 52. FIG. 5 is a screen for telling the user to wait to replace the first battery 110 while the LED (notifier 70) is blinking red.

As the first step of the procedure for replacing the first battery 110, FIG. 5 tells the user to start the transition to the battery replacement mode by tapping a “Start” button (icon). FIG. 5 also tells the user that once the transition to the battery replacement mode starts, the screen (the display on the display 52) will turn off and the LED (notifier 70) will start blinking red. FIG. 5 also tells the user that the transition to the battery replacement mode can be canceled by pressing the operable element (power key) 62 while the LED (notifier 70) is blinking red.

If the user taps the touch panel 54 at the position of the “Next” icon displayed on the display 52 illustrated in FIG. 5, the controller 10 may display a screen like the one illustrated in FIG. 6 as the next screen on the display 52.

As the next step of the procedure for replacing the first battery 110, FIG. 6 tells the user that when the transition to the battery replacement mode starts, the LED (notifier 70) will turn green to indicate that the first battery 110 is ready to be replaced. FIG. 6 also tells the user that the replacement of the first battery 110 (replacement from the first battery 110A to the first battery 110B) should be completed within two minutes. The time available for replacement of the first battery 110 is not limited to being within two minutes, and may be set as appropriate according to the power and/or time that the second battery 120 is capable of supplying, for example.

If the user taps the touch panel 54 at the position of the “Next” icon displayed on the display 52 illustrated in FIG. 6, the controller 10 may display a screen like the one illustrated in FIG. 7 as the next screen on the display 52.

As the step of the procedure after replacing the first battery 110A with the first battery 110B, FIG. 7 tells the user that the user can perform a long-press operation on the operable element (power key) 62 to resume operations by the electronic device 1. FIG. 7 also tells the user that after replacing the first battery 110A with the first battery 110B, the user should close the rear cover (the housing or at least a portion thereof, such as a lid) and power on the electronic device 1.

If the user taps the touch panel 54 at the position of the “Next” icon displayed on the display 52 illustrated in FIG. 7, the controller 10 may display a screen like the one illustrated in FIG. 8 as the next screen on the display 52.

FIG. 8 may present the user with various information prompting the user to take final precautions before replacing the first battery 110.

If the user taps the touch panel 54 at the position of the “Start” icon displayed on the display 52 illustrated in FIG. 8, the controller 10 may proceed to the processing in the next step S13.

A user who has had experience replacing the first battery 110 in the past is assumed to already have some grasp of the explanations like those illustrated in FIGS. 5 to 8, and may want to bypass such explanations. In one embodiment, the electronic device 1 may cause different explanations to be displayed on the display 52, depending on whether the user desiring replacement of the first battery 110 is performing the predetermined operation for the first time or performing the predetermined operation for the second or subsequent time.

For example, if the user desiring replacement of the first battery 110 is performing the predetermined operation for the first time, the controller 10 may carry out control to present displays like those illustrated in FIGS. 5 to 8 on the display 52. On the other hand, if the user desiring replacement of the first battery 110 is performing the predetermined operation for the second or subsequent time, the controller 10 may carry out control to present a display like the one illustrated in FIG. 9 on the display 52, instead of displays like those illustrated in FIGS. 5 to 8.

FIG. 9 illustrates explanations like those illustrated in FIGS. 5 to 8, simplified to fit on a single screen.

If the user taps the touch panel 54 at the position of the “Start” icon displayed on the display 52 illustrated in FIG. 9, the controller 10 may proceed to the processing in the next step S13. On the other hand, if the user taps the touch panel 54 at the position of the “Check Details and Start” icon displayed on the display 52 illustrated in FIG. 9, the controller 10 may carry out control to present displays like those illustrated in FIGS. 5 to 8 on the display 52 again.

In this way, on the basis of a determination that a transition to the battery replacement mode is possible, the controller 10 may carry out control to display different content on the display depending on whether the predetermined operation by the user is being detected for the first time.

After step S12, the controller 10 acquires information about at least one of the state of the electronic device 1 or the state of the second battery 120 (step S13). In this way, when a predetermined operation (operation for starting the transition to the battery replacement mode) by the user is detected, the controller 10 may use at least one of the state of the electronic device 1 or the state of the second battery 120 as a basis for determining whether a transition to the battery replacement mode is possible.

Upon acquiring information about at least one of the state of the electronic device 1 or the state of the second battery 120 in step S13, the controller 10 uses the information as a basis for determining whether the electronic device 1 can transition to the battery replacement mode (step S14).

In one embodiment, the controller 10 may acquire information indicating whether the electronic device 1 is in the middle of a voice call, as an example of the “state of the electronic device 1” above. In this case, the controller 10 may determine that a transition to the battery replacement mode is not possible, on the basis of the state of the electronic device 1 being that the communicator 30 with a voice call function is executing the voice call function (step S14).

In one embodiment, the controller 10 may acquire information indicating whether the electronic device 1 is waiting for a callback during execution of a callback function, as an example of the “state of the electronic device 1” above. The callback function may be a function that the electronic device 1 transitions to when a call is terminated, and allows an operator to call the user back. In this case, the controller 10 may determine that a transition to the battery replacement mode is not possible, on the basis of the state of the electronic device 1 being that the communicator 30 is waiting for a call back during execution of the callback function (step S14).

In one embodiment, the controller 10 may acquire information about the temperature of the second battery 120 as detected by the detector 20, as an example of the “state of the second battery 120” above. If the power source to switch to, namely the second battery 120, has an abnormally high or abnormally low temperature, the original performance of the second battery 120 may not be exhibited after switching to the second battery 120 to supply power to the electronic device 1. Consequently, the controller 10 may determine that a transition to the battery replacement mode is not possible, on the basis of the state of the second battery 120 being that the temperature of the second battery 120 as detected by the detector 20 is higher than a first threshold or lower than a second threshold (step S14).

In one embodiment, the controller 10 may acquire information about the voltage of the second battery 120 as detected by the detector 20, as an example of the “state of the second battery 120” above. If the power source to switch to, namely the second battery 120, has an abnormally low voltage, the original performance of the second battery 120 may not be exhibited after switching to the second battery 120 to supply power to the electronic device 1. Consequently, the controller 10 may determine that a transition to the battery replacement mode is not possible, on the basis of the state of the second battery 120 being that the voltage of the second battery 120 as detected by the detector 20 is lower than a third threshold (step S14).

In one embodiment, the controller 10 may acquire information pertaining to degradation of the second battery 120 as detected by the detector 20, as an example of the “state of the second battery 120” above. If the power source to switch to, namely the second battery 120, has degraded to a certain degree or more, the original performance of the second battery 120 may not be exhibited after switching to the second battery 120 to supply power to the electronic device 1. Consequently, the controller 10 may determine that a transition to the battery replacement mode is not possible, on the basis of the state of the second battery 120 being that the degradation of the second battery 120 as detected by the detector 20 is higher than a fourth threshold (step S14).

In one embodiment, the controller 10 may acquire information about an abnormality pertaining to the second battery 120 as detected by the detector 20, as an example of the “state of the second battery 120” above. If the power source to switch to, namely the second battery 120, is abnormal, the original performance of the second battery 120 may not be exhibited after switching to the second battery 120 to supply power to the electronic device 1. Consequently, the controller 10 may determine that a transition to the battery replacement mode is not possible, on the basis of the state of the second battery 120 being that the detector 20 detects an abnormality pertaining to the second battery 120 (step S14).

Upon determining in step S14 that a transition to the battery replacement mode is not possible, the controller 10 may end the operations illustrated in FIG. 3 without transitioning to the battery replacement mode. In this case, the controller 10 may present the reason for not transitioning to the battery replacement mode to the display 52 and/or the notifier 70, for example.

For example, if the state of the second battery 120 is that the temperature of the second battery 120 as detected by the detector 20 is higher than the first threshold, the controller 10 may present a display like the one illustrated in FIG. 10 on the display 52. FIG. 10 illustrates a display presented on the display 52 to indicate that a transition to the battery replacement mode is not possible because an abnormally high temperature of the second battery 120 was detected.

As another example, if the state of the second battery 120 is that the detector 20 detects an abnormality pertaining to the second battery 120, such as a fault with the second battery 120, the controller 10 may present a display like the one illustrated in FIG. 11 on the display 52. FIG. 11 illustrates a display presented on the display 52 to indicate that a transition to the battery replacement mode is not possible because a fault with the second battery 120 was detected.

As another example, if the state of the second battery 120 is that the degradation of the second battery 120 as detected by the detector 20 is higher than the fourth threshold, the controller 10 may present a display like the one illustrated in FIG. 12 on the display 52. FIG. 12 illustrates a display presented on the display 52 to indicate that a transition to the battery replacement mode is not possible because a certain degree or more of degradation of the second battery 120 was detected.

In this way, the electronic device 1 may be provided with the notifier 70 or the display 52 to notify the user of certain information (via a pop-up display or turning on/blinking/turning off an LED, for example). In this case, the controller 10 may control the notifier 70 or the display 52 to provide different notifications depending on the determination of whether a transition to the battery replacement mode is or is not possible.

The controller 10 may also control the display 52 to display certain information as follows. The certain information may be, for example, an indication that the electronic device 1 is in the middle of a voice call, information pertaining to the temperature of the second battery 120, information pertaining to the voltage of the second battery 120, information pertaining to the degradation of the second battery 120, or information pertaining to an abnormality of the second battery 120.

On the other hand, upon determining in step S14 that the electronic device 1 can transition to the battery replacement mode, the controller 10 carries out control to turn off the display on the display 52 (step S15). In step S15, the controller 10 may carry out control to turn off a display being displayed on the display 52, such as the display illustrated in FIG. 8.

The controller 10 may provide to the display 52, the notifier 70, and/or the like a notification indicating to wait to replace the first battery 110 of the electronic device 1 (step S16). The situation that the user is asked to perform in step S16 may be a situation in accordance with the explanation displayed on the display 52 illustrated in FIG. 5.

The controller 10 limits the functionality of the electronic device 1 (step S17). The limiting of the functionality of the electronic device 1 may be at least one of turning on an airplane mode or other in-cabin mode, disabling input other than the power key (operable element 62), unmounting an SD card, SIM card, and/or the like, or limiting the CPU of the electronic device 1, for example. Limiting the functionality of the electronic device 1 in step S17 may reduce the current required for operations by the electronic device 1.

The controller 10 acquires information on the amount of current required for operations by the electronic device 1 (step S18). The amount of current required for operations by the electronic device 1 may be reduced to some extent by the limiting of functionality in step S17.

The controller 10 determines whether the electronic device 1 can transition to the battery replacement mode (step S19). The processing executed in step S19 may be the same and/or similar to the processing described in step S14. On the other hand, the processing executed in step S19 may be different from the processing described in step S14. For example, in step S19, the controller 10 may determine whether the current required for operations by the electronic device 1 has been reduced to such an extent that the amount of current required for operations by the electronic device 1 can be obtained after switching the power source to the second battery 120.

Upon determining in step S19 that a transition to the battery replacement mode is not possible, the controller 10 may end the operations illustrated in FIG. 3 without transitioning to the battery replacement mode. In this case, the controller 10 may present the reason for not transitioning to the battery replacement mode to the display 52 and/or the notifier 70, for example.

On the other hand, upon determining in step S19 that the electronic device 1 can transition to the battery replacement mode, the controller 10 controls the electronic device 1 to transition to the battery replacement mode (step S20). In step S20, the controller 10 may carry out control to switch from a supply of power from the first battery 110A to a supply of power from the second battery 120.

After the transition to the battery replacement mode in step S20, the controller 10 may provide to the display 52, notifier 70, and/or the like a notification indicating that the first battery 110 can be replaced (step S21). The situation that the user is asked to perform in step S21 may be a situation in accordance with the explanations displayed on the display 52 illustrated in FIGS. 6 and 7.

That is, by perceiving the notification in step S21, the user can grasp the timing for replacing the first battery 110A of the electronic device 1 with the first battery 110B.

Assume that after step S21, the user removes the first battery 110A from the electronic device 1 and connects the first battery 110B to the electronic device 1 as a replacement.

In this way, the controller 10 may cause the notifier 70 or the display 52 to provide different notifications before the time when a transition to the battery replacement mode is possible (first battery removal is not allowed) and from the time when a transition to the battery replacement mode is possible (first battery removal is allowed).

FIG. 13 is a flowchart illustrating an example of operations by the electronic device according to an embodiment. FIG. 13 may illustrate operations after the user replaces the first battery 110 of the electronic device 1 according to the flowchart illustrated in FIG. 3. That is, it may be assumed that at the time when the operations illustrated in FIG. 13 start, the user has replaced the first battery 110A of the electronic device 1 with the first battery 110B.

When the operations illustrated in FIG. 13 start, the controller 10 determines whether a predetermined operation by the user to power on the electronic device 1 is detected (step S31). The predetermined operation by the user to power on the electronic device 1 may be any of various predefined operations for when the user powers on the electronic device 1. For example, the controller 10 may assume that the electronic device 1 is powered on based on the user long-pressing or short-pressing the operable element (power key) 62.

If the predetermined power-on operation by the user is not detected in step S31, the controller 10 may return to step S31 and continue operations.

If the electronic device 1 is powered on in step S31, the controller 10 removes the limitation on the functionality of the electronic device 1 (step S32). In step S32, the controller 10 may remove the limitation on the functionality of the electronic device 1 that was imposed in step S17 illustrated in FIG. 3. The removal of the limitation on the functionality of the electronic device 1 may be at least one of enabling input other than the power key (operable element 62), mounting an SD card, SIM card and/or the like, or removing a limit on the CPU of the electronic device 1, for example.

The controller 10 may provide to the display 52, the notifier 70, and/or the like a notification indicating that the replacement of the first battery 110 of the electronic device 1 is complete (step S33). For example, the controller 10 may present a display like the one illustrated in FIG. 14 on the display 52 to indicate that the replacement of the first battery 110 of the electronic device 1 is complete. In FIG. 14, an indication that replacement of the first battery 110 in the electronic device 1 is complete is displayed on the display 52.

The controller 10 may carry out control to turn on a display on the display 52 of the electronic device 1 (step S34). The display on the display 52 that is turned on in step S34 may be the display on the display 52 that was turned off in step S15 illustrated in FIG. 3, for example.

The controller 10 may carry out control to exit the battery replacement mode of the electronic device 1 (step S35). In step S35, the controller 10 may carry out control to exit the battery replacement mode that the electronic device 1 transitioned to in step S20 illustrated in FIG. 3. That is, in step S35, the controller 10 may carry out control to switch from a supply of power from the second battery 120 to a supply of power from the first battery 110B.

As described above, in one embodiment, the electronic device 1 checks the state of the electronic device 1 and/or the state of the second battery 120 before transitioning to the battery replacement mode. In one embodiment, the electronic device 1 checks the temperature, capacity, degree of degradation, and/or abnormality of the second battery 120 as the state of the second battery 120. In one embodiment, the electronic device 1 checks whether it is possible to transition to a state of minimal current draw and/or whether transitioning to the battery replacement mode at the current time would disadvantage the user as the state of the electronic device 1.

Consequently, according to one embodiment of the electronic device 1, the capacity of the second battery 120 can be reduced to the minimum necessary, for example. According to one embodiment of the electronic device 1, the state of the electronic device 1 can also be checked to confirm whether transitioning to a state of minimal current draw would disadvantage the user. Consequently, in one embodiment, the electronic device 1 can smoothly switch to power supplied by the second battery 120 without interrupting power to the electronic device 1, even with a second battery 120 of relatively low capacity.

The present disclosure has been described on the basis of the drawings and examples, but note that a person skilled in the art could easily make various variations or revisions on the basis of the present disclosure. Consequently, it should be understood that these variations or revisions are included in the scope of the present disclosure. For example, the functions and the like included in each functional unit may be rearranged in logically non-contradictory ways. Multiple functional units or the like may be combined into one, or a functional unit may be divided. Each embodiment according to the present disclosure described above is not limited to being carried out exactly according to each embodiment as described, and may be carried out by combining features or omitting some features, as appropriate. In other words, the content of the present disclosure enables a person skilled in the art to make various variations and revisions on the basis of the present disclosure. Therefore, these variations and revisions are included in the scope of the present disclosure. For example, in each embodiment, each functional unit, means, step, and the like can be added to another embodiment or replaced by each functional unit, means, step, and the like of another embodiment in logically non-contradictory ways. In each embodiment, multiple functional units, means, steps, and the like can be combined into one, or each functional unit, means, step, and the like can be divided. Each embodiment according to the present disclosure described above is not limited to being carried out exactly according to each embodiment as described, and can be carried out by combining features or omitting some features, as appropriate.

The embodiments described above are not limited solely to embodiments of the electronic device 1. For example, the embodiments described above may also be carried out as a method of controlling a device like the electronic device 1. Furthermore, the embodiments described above may also be carried out as a program to be executed by a device like the electronic device 1, for example, or as a storage medium or recording medium in which the program is recorded.

Many aspects of the content of the present disclosure are illustrated as a series of operations to be executed by a computer system or other hardware capable of executing program instructions. The computer system or other hardware includes, for example, a general-purpose computer, a personal computer (PC), a special-purpose computer, a workstation, a personal communications system (PCS), a mobile (cellular) phone, a mobile phone with data processing functions, an RFID receiver, a game console, an electronic notepad, a laptop computer, a Global Positioning System (GPS) receiver, or some other programmable data processing device. Note that in each embodiment, the various operations or the method of controlling is performed by a dedicated circuit (for example, individual logic gates interconnected to perform a specific function) implemented with program instructions (software) or by a logic block, program module, and/or the like executed by at least one processor. The at least one processor that executes the logic block, program module, and/or the like includes, for example, at least one microprocessor, central processing unit (CPU), application-specific integrated circuit (ASIC), digital signal processor (DSP), programmable logic device (PLD), field-programmable gate array (FPGA), processor, controller, microcontroller, microprocessor, electronic device, or other device designed to execute the functions described herein, and/or a combination of any of the above. The embodiments illustrated herein are implemented by, for example, hardware, software, firmware, middleware, microcode, or a combination of any of the above. An instruction may be program code or a code segment for executing a required task. An instruction can be stored in a non-transitory machine-readable storage medium or other medium. A code segment may represent any combination of procedures, functions, subprograms, programs, routines, subroutines, modules, software packages, classes or instructions, data structures or program statements. A code segment transmits and/or receives information, a data argument, a variable, or stored content to and/or from another code segment or a hardware circuit, thereby connecting the code segment to the other code segment or hardware circuit.

The memory 12 used herein furthermore can be configured as a computer-readable tangible carrier (medium) formed according to the categories of solid-state memory, magnetic disks, and optical discs. Such a medium stores an appropriate set of computer instructions or data structures, such as a program module, to cause a processor to perform the technology disclosed herein. The computer-readable medium includes an electrical connection with one or more wires, a magnetic disk storage medium, a magnetic cassette, magnetic tape, other magnetic and optical storage devices (for example, Compact Disc (CD), LaserDisc®, Digital Versatile Disc (DVD®), Floppy® disk, and Blu-ray Disc®), a portable computer disk, random access memory (RAM), read-only memory (ROM), ROM that is rewritable and programmable, such as erasable programmable read-only memory (EPROM), electrically erasable programmable read-only memory (EEPROM), and/or flash memory, another tangible storage medium capable of storing information, and/or a combination of any of the above. Memory can be provided internally and/or externally to a processor or processing unit. As used herein, the term “memory” means any kind of long-term, short-term, volatile, non-volatile, and/or other memory. That is, “memory” is not limited to a specific type and/or number. The type of medium in which memories are stored is also not limited.

What is claimed is:

1. An electronic device comprising:
a first battery;
a second battery; and
a controller, wherein
the controller is configured to
operate the electronic device with power supply from the first battery in a first mode,
operate the electronic device with power supply from the second battery in a second mode,
detect a predetermined operation by a user of electronic device, and
determine whether switching from the first mode to the second mode is possible based on at least one of a first state of the electronic device and a second state of the second battery when the predetermined operation is detected in the first mode.

2. The electronic device according to claim 1, wherein
the first state includes a first condition in which the electronic device is executing a voice call function, and
the controller is configured to determine that switching from the first mode to the second mode is not possible when the first condition is detected in the first mode.

3. The electronic device according to claim 1, wherein
the first state includes a second condition in which the electronic device is executing a callback function, and
the controller is configured to determine that switching from the first mode to the second mode is not possible when the second condition is detected in the first mode.

4. The electronic device according to claim 1, further comprising:
a detector configured to detect the temperature of the second battery, wherein
the second state includes a third condition where the detected temperature is higher than a first threshold, and
the controller is configured to determine that switching from the first mode to the second mode is not possible when the third condition is determined in the first mode.

5. The electronic device according to claim 1, further comprising:
a detector configured to detect the temperature of the second battery, wherein
the second state includes a fourth condition where the detected temperature is lower than a second threshold, and
the controller is configured to determine that switching from the first mode to the second mode is not possible when the fourth condition is determined in the first mode.

6. The electronic device according to claim 1, further comprising:
a detector configured to detect the voltage of the second battery,
the second state includes a fifth condition where the detected voltage is lower than a third threshold, and
the controller is configured to determine that switching from the first mode to the second mode is not possible when the fifth condition is determined in the first mode.

7. The electronic device according to claim 1, wherein
the second state includes a sixth condition in which the second battery has a predetermined degree of deterioration, and
the controller is configured to
estimate that the second battery has the predetermined degree based on first information related to the second battery, and
determine that switching from the first mode to the second mode is not possible when the sixth condition is determined in the first mode.

8. The electronic device according to claim 1, wherein
the second state includes a seventh condition in which the second battery is in a predetermined abnormal condition, and
the controller is configured to
estimate that the second battery is in the predetermined abnormal condition based on second information related to the second battery, and
determine that switching from the first mode to the second mode is not possible when the seventh condition is determined in the first mode.

9. The electronic device according to claim 1, further comprising:
a notifier, wherein
the controller is configured to control the notifier to provide different notifications based on the determination of whether switching from the first mode to the second mode is possible.

10. The electronic device according to claim 1, further comprising
a notifier, wherein
the controller is configured to control the notifier to change the manner of notification to the user based on the determination of whether switching from the first mode to the second mode is possible.

11. The electronic device according to claim 1, further comprising:
a display, wherein
the controller is configured to
display a first image on the display when the number of detections of the predetermined operation satisfies a first count and it is determined that switching from the first mode to the second mode is possible, and
display a second image on the display when the number of detections of the predetermined operation satisfies a second count that is greater than the first count and it is determined that switching from the first mode to the second mode is possible.

12. A method for operating an electronic device comprising a first battery and a second battery, the method comprising:
operating the electronic device in a first mode using power supplied from the first battery;
operating the electronic device in a second mode using power supplied from the second battery;
detecting a predetermined operation by a user of the electronic device; and
determining whether switching from the first mode to the second mode is possible based on at least one of a first state of the electronic device and a second state of the second battery when the predetermined operation is detected in the first mode.
